(19) United States
(12) Patent Application Publication
(10) Pub. No.: US 2024/0425692 A1
(43) Pub. Date: Dec. 26, 2024

(54) 3D PRINTING RESIN COMPOSITION AND FLUORESCENT IMPLANT GUIDE FOR TRANSPARENT STRUCTURE, AND MANUFACTURING METHOD THEREOF

(71) Applicant: In Sun JEONG, Gwangju (KR)

(72) Inventor: In Sun JEONG, Gwangju (KR)

(21) Appl. No.: 18/678,117

(22) Filed: May 30, 2024

(30) Foreign Application Priority Data
Jun. 26, 2023 (KR) 10-2023-0081874
Aug. 9, 2023 (KR) 10-2023-0104295

(51) Int. Cl. C08L 33/06; A61C 8/00; B33Y 70/00; C09K 11/06

(52) U.S. Cl. CPC C08L 33/068; A61C 8/0089; B33Y 70/00; C09K 11/06; C09K 2211/1029

(57) ABSTRACT

The present invention relates to a 3D printing resin composition including bisphenol A-glycidyl methacrylate (BIS-GMA), ethoxylated bisphenol A dimethacrylate (BIS-EMA), urethane dimethacrylate (UDMA), a photoinitiator, an additive, a coloring aid, a filler, a viscosity modifier, and a fluorescent coloring agent, a fluorescent implant guide manufactured using the same, and a manufacturing method thereof, and an implant guide or a dental structure manufactured through 3D printing using the 3D printing resin composition according to the present invention has effects and advantages that a placement location, a direction, a depth, and the like of the dental structure are more efficiently visible during various dental procedures by emitting fluorescence when irradiated with light.

### CROSS-REFERENCE TO RELATED PATENT APPLICATION

This application claims the benefit of Korean Patent Application No. 10 10-2023-0081874, filed on Jun. 26, 2023, and Korean Patent Application No. 10-2023-0104295, filed on Aug. 9, 2023, in the Korean Intellectual Property Office, the disclosure of which is incorporated herein in its entirety by reference.

### TECHNICAL FIELD

The present invention relates to a 3D printing resin composition having fluorescent characteristics and a manufacturing method thereof, and a fluorescent implant guide manufactured using the same and a manufacturing method thereof in which the fluorescent implant guide manufactured using the 3D printing resin composition according to the present invention is able to more effectively guide a placement location, a direction, a depth, and the like of the implant due to the fluorescent characteristics.

### BACKGROUND

In general, when a tooth is lost due to damage or loss by caries or fracture, problems in speech, chewing, and aesthetics occur. When the normal alignment of the teeth begins to become misaligned as adjacent teeth move into the empty space where there are no teeth, food gets stuck in between the teeth, causing a problem of cavities, tooth decay, or worsening bad breath occurs.

To solve such a problem, when a patient has lost part or all of his or her teeth, all natural teeth in the dental arch and the gum area associated with them are replaced with artificial objects, and dental restorative resin is applied to the area where the teeth were lost in order to maintain or restore the function of the oral cavity.

Various dental structures, including the dental restorative resin, require an operator (dentist) to be able to easily and accurately check the positions of the dental structures, and sufficient strength is required to prevent damage during drilling or punching.

Therefore, research and development on 3D printing resin compositions are needed in which the restorative resin or the dental structures customized to the patient can be manufactured while, at the same time, increasing the convenience of the operator, and side effects such as bleeding, swelling, and infection at the beginning of the procedure, as well as dislodgement, fracture, and nerve damage after the procedure can be minimized.

Meanwhile, the implant guide is used to plan the placement location of the dental implant to be applied to the patient during the implant procedure and guide the placement location, the direction, the angle, the depth, and the like based on the results thereof, and is configured to include a guide body that negatively corresponds to the patient's oral structure during the dental implant procedure and a guide hole that guides the placement location of the implant.

Since the processes of drilling, punching, placement, and the like for implant placement are performed by being guided by the guide hole, the implant procedure can be performed at the initially designed placement location and placement angle, and dependence on surgical skill can be reduced.

Accordingly, in the field of dentistry, the development of devices and instruments for accurately placing the implants in the planned locations during dental implant procedures based on patient's oral cavity information acquired using oral scanners and the like has recently become active. Accordingly, the implant guide market manufactured with 3D printers is also growing rapidly.

In order for the implant guide to perform its role more safely, the operator (dentist) must be able to easily check the position of the guide hole, and the implant guide must have sufficient strength not to be damaged during drilling or punching. However, due to the recent rapid market growth, there is an increasing number of implant guides being manufactured and distributed that do not sufficiently perform their role as a guide, such as having non-uniform physical properties or including cytotoxicity. In addition, side effects such as bleeding, swelling, and infection at the beginning of the procedure, as well as dislodgement, fracture, and nerve damage after the procedure due to the use of such defective guides occur.

Due to these problems, there is a need for implant guide products that can faithfully perform the role of the implant guide and are safe.

### SUMMARY OF INVENTION

### Technical Problem

The present invention relates to a 3D printing resin composition and a manufacturing method thereof in which fluorescent characteristics can be imparted to a dental structure such as an implant guide, tooth restoration resin, or the like, thereby allowing an operator to more effectively recognize a location, a direction, a depth, and the like of the dental structure or the like while at the same time securing sufficient physical and mechanical strength by providing the 3D printing resin composition with fluorescent characteristics and the manufacturing method thereof.

In addition, the present invention includes an implant guide having fluorescent characteristics, which can be manufactured by a method such as 3D printing using the resin composition and a manufacturing method thereof, and provides a fluorescent implant guide that can effectively guide a placement location, a direction, a depth, and the like of the implant when the implant guide is used in dental implant procedure.

### Technical Solution

A 3D printing resin composition according to one embodiment of the present invention includes bisphenol A-glycidyl methacrylate (BIS-GMA), ethoxylated bisphenol A dimethacrylate (BIS-EMA), urethane dimethacrylate (UDMA), a photoinitiator, an additive, a coloring aid, a filler, a viscosity modifier, and a fluorescent coloring agent.

The fluorescent coloring agent is preferably 4′,6-Diamidino-2-phenylindole dihydrochloride (DAPI), and is more preferably included in a range of 0.2 wt % or more to less than 1.6 wt %. In addition, the additive may be at least one or more of an accelerator, an antioxidant, and a photoinitiation aid.

A manufacturing method of a 3D printing resin composition according to another embodiment of the present invention, the manufacturing method includes a first mixing step of mixing BIS-GMA, BIS-EMA, and UDMA and stirring to manufacture a first mixture; a second mixing step of adding a photoinitiator and an additive to the first mixture and stirring to manufacture a second mixture; a third mixing step of adding a coloring agent mixture to the second mixture and stirring to manufacture a third mixture; a fourth mixing step of adding a filler to the third mixture and stirring to manufacture a fourth mixture; and a fifth mixing step of adding a viscosity modifier to the fourth mixture and stirring to manufacture a composition for an implant guide.

The coloring agent mixture is a mixture of UDMA, a fluorescent coloring agent, and a coloring aid, the fluorescent coloring agent is preferably 4′,6-Diamidino-2-phenylindole dihydrochloride (DAPI), and the fluorescent coloring agent is more preferably included in a range of 0.2 wt % or more to less than 1.6 wt %.

A fluorescent implant guide including a guide body in which at least one or more holes are formed according to another embodiment of the present invention, in which the guide body is formed by curing a composition for an implant guide including BIS-GMA, BIS-EMA, UDMA, a photoinitiator, an additive, a coloring aid, a filler, a viscosity modifier, and a fluorescent coloring agent.

The fluorescent coloring agent is preferably 4′,6-Diamidino-2-phenylindole dihydrochloride (DAPI) and the content of the fluorescent coloring agent included in the composition for the implant guide is more preferably 0.2 wt % or more to less than 1.6 wt %.

The composition for the implant guide may include 30 to 60 wt % of BIS-GMA, 10 to 30 wt % of BIS-EMA, 5 to 30 wt % of UDMA, 1 to 10 wt % of the photoinitiator, 0.01 to 5 wt % of the additive, 0.1 to 5 wt % of the coloring aid, 0.5 to 8 wt % of the filler, 1 to 25 wt % of the viscosity modifier, and 0.2 wt % or more to less than 1.6 wt % of the fluorescent coloring agent.

The fluorescent implant guide may be manufactured through a guide design step of designing a shape of an implant guide based on patient's oral cavity information; an implant guide composition manufacturing step of mixing BIS-GMA, BIS-EMA, UDMA, a photoinitiator, an additive, a coloring aid, a filler, a viscosity modifier, and a fluorescent coloring agent to manufacture the composition for implant guide; and an implant guide manufacturing step of manufacturing a patient-customized fluorescent implant guide by 3D printing the composition for the implant guide in the form of the implant guide designed in the guide design step.

At this time, the implant guide composition manufacturing step may include a first mixing step of mixing BIS-GMA, BIS-EMA, and UDMA and stirring to manufacture a first mixture; a second mixing step of adding the photoinitiator and the additive to the first mixture and stirring to manufacture a second mixture; a third mixing step of adding a coloring agent mixture to the second mixture and stirring to manufacture a third mixture; a fourth mixing step of adding the filler to the third mixture and stirring to manufacture a fourth mixture; and a fifth mixing step of adding the viscosity modifier to the fourth mixture and stirring to manufacture the composition for the implant guide, in which the coloring agent mixture is preferably a mixture of UDMA, the fluorescent coloring agent, and the coloring aid.

The fluorescent coloring agent is preferably 4′,6-Diamidino-2-phenylindole dihydrochloride (DAPI).

### Advantageous Effects

The 3D printing resin composition according to the present invention has advantages that not only the dental structure such as the dental implant guide with excellent mechanical strength can be manufactured through 3D printing, but also the placement location, the direction, the depth, and the like of the dental structure can be more efficiently guided during various dental procedures by emitting fluorescence when irradiated with light.

### BRIEF DESCRIPTION OF THE DRAWINGS

FIGS. 1-4 are photographs showing results of a fluorescence experiment in Experimental Example 3 of the present invention.

### BEST MODE FOR INVENTION

Hereinafter, the present invention will be described in detail through preferred embodiments. Prior to the description, it is clear that the terms and words used in the specification and claims of the present invention are not limited to ordinary or dictionary meanings, and should be interpreted with meanings and concepts consistent with the technical idea of the present invention.

Throughout this specification, when it is said that a part “includes” a certain element, this means that it may further include other elements, rather than excluding other elements, unless specifically stated to the contrary.

In addition, throughout this specification, “%” used to indicate the concentration of a specific substance means (weight/weight) % for solid/solid, (weight/volume) % for solid/liquid, and (volume/volume) % for liquid/liquid unless otherwise specified.

An identification code for each step is used for convenience of explanation. The identification code does not explain the order of each step, and each step may be performed differently from the specified order unless a specific order is clearly stated in the context. That is, each step may be performed in the same order as specified, may be performed substantially simultaneously, or may be performed in the opposite order.

Below, specific embodiments of the present invention will be described. However, the scope of the present invention is not limited to the following preferred embodiments. Additionally, anyone who has ordinary knowledge of the present invention at the time of application can implement various modifications of the contents described in the specification within the scope of protection of the present invention.

First, the 3D printing resin composition according to the present invention is a composition that can manufacture a dental structure such as a dental fluorescent implant guide or tooth restoration resin through 3D printing. In a case where the dental structure such as the implant guide or the tooth restoration resin is manufactured by using the 3D printing resin composition, since fluorescence is emitted when irradiated with light, it can accurately guide the position, angle, direction, and depth of perforation, drilling, and implant placement during dental procedures, thereby preventing side effects such as perforation or placement location errors, abnormal bleeding, swelling, infection, and nerve damage in advance, and enabling safe and more accurate dental procedures.

The 3D printing resin composition according to an embodiment of the present invention includes BIS-GMA, BIS-EM, UDMA, photoinitiator, additive, coloring aid, filler, viscosity modifier, and fluorescent coloring agent, and the resin composition is cured after 3D printing, and thereby a dental structure such as a fluorescent implant guide can be formed.

More specifically, the 3D printing resin composition may include 30 to 60 wt % of BIS-GMA, 10 to 30 wt % of BIS-EMA, 5 to 30 wt % of UDMA, 1 to 10 wt % of photoinitiator, 0.01 to 5 wt % of additive, 0.1 to 5 wt % of coloring aid, 0.5 to 8 wt % of filler, 1 to 25 wt % of viscosity modifier, and 0.2 wt % or more to less than 1.6 wt % of fluorescent coloring agent.

The BIS-GMA, BIS-EMA, and UDMA form a basic skeleton of the dental structure. Since they are transparent after curing, they are not only suitable for use as the dental structure such as implant guide and the orthodontic device, but also can be vividly colored without inhibiting the color development caused by fluorescent coloring agents or coloring aids.

Among these, the BIS-GMA includes two hydrophobic methacrylic groups, has low volatility and polymerization shrinkage, cures quickly, has a large molecular weight, and is highly stable, thereby making it suitable as a matrix resin. However, due to its high viscosity, it is difficult to stir it evenly with other ingredients and its workability is poor, so it is preferable to use the BIS-GMA with the BIS-EMA to lower the viscosity.

The BIS-GMA may be pure BIS-GMA, modified BIS-GMA, or a mixture including both, where the modified BIS-GMA may contain at least one or more of DMBIS-GMA (2,2-bis [3-methyl, 4-(2-hydroxy-3-methacryloyloxy propoxy) phenyl] propan) and TMBIS-GMA (2,2-bis [3-methyl, 4-(2-hydroxy-3-methacryloyloxy propoxy) phenyl] propan).

In particular, it is preferable that the modified BIS-GMA which has significantly high strength after curing is used to sufficiently withstand the force applied to the implant guide during the drilling operation, and it is more preferable that the DMBIS-GMA that is the modified BIS-GMA to secure even improved strength.

The BIS-GMA may be included at 30 to 60 wt % in the entire composition, and it is preferable that the BIS-GMA is included within the above weight range, because it is difficult to secure sufficient strength if the BIS-GMA is included in less than the above weight range, and the stirring process is difficult due to excessively high viscosity if the BIS-GMA is included in more than the above weight range.

The BIS-EMA may be included at 10 to 30 wt % in the entire composition, and it is preferable that the BIS-EMA is included within the above weight range, because sufficient viscosity reduction for uniform stirring is not achieved if the BIS-EMA is included in less than the above weight range, and it is difficult to secure sufficient strength and may be a formulation that is difficult to apply to 3D printing due to excessively high viscosity if the BIS-EMA is included in more than the above weight range.

The UDMA is added to reduce polymerization shrinkage, improve elasticity and toughness, as well as uniformly disperse the fluorescent coloring agents or coloring aids, and may be included at 5 to 30 wt % in the entire composition. There is a problem that it is difficult to secure sufficient bending strength because it is difficult to obtain the above-described effects of the UDMA if the content of the UDMA is less than the above range, and the content of BIS-GMA is relatively reduced if the content of UDMA is more than the above range.

The photoinitiator is an ingredient that is activated by light irradiation to form radicals, and the formed radicals can cause a photopolymerization reaction of the BIS-GMA, the BIS-EMA, and the UDMA to induce a curing reaction of the dental 3D printing resin composition.

It is preferable that such a photoinitiator is included at 1 to 10 wt % in the entire composition to cause a sufficient photocuring reaction. As a specific photoinitiator, for example, a curing agent for a dental curing material such as camphorquinone or TPO (2.4.6-trimethyl benzoyl-diphenylphosphine oxide) can be used. However, it is not necessarily limited to these ingredients as the photoinitiator ingredient, and any photoinitiator can be applied to the present invention as long as the photoinitiator can be applied to the dental equipment or material. In order to secure particularly desirable curing characteristics and safety, either camphorquinone or TPO may be used, and more preferably, a mixture thereof may be used.

The additive is added to improve the curing characteristics or physical and chemical characteristics of the dental 3D printing resin composition. Any one or more of an accelerator, antioxidant, and photoinitiation aid may be used as the additive. It is preferable that the additive is included in a weight proportion of 0.01 to 5 wt % in the entire composition.

The accelerator may be added to promote photoinitiation by increasing the radical generation efficiency of the photoinitiator by light irradiation. As the accelerator, for example, at least one selected from the group consisting of EDMAB (ethyl (4-dimethyl amino) benzoate), DMABA (4-(dimethylamino)benzoic acid), DMABZR (4-(dimethylamino)benzaldehyde), DMAEMA (2-(dimethylamino)ethyl methacrylate), DMAEA (2-(dimethylamino)ethyl acrylate), DEAEMA (2-(diethylamino)ethyl methacrylate), and DEAEA (2-(diethylamino)ethyl acrylate) may be used, but is not necessarily limited to these, and the accelerator may be included at 0.05 to 2 wt % in the entire 3D printing resin composition.

Antioxidants are added to prevent oxidative deterioration of the 3D printing resin composition or the dental structure 3D printed using it, and BHT (butylated hydroxy toluene) or commercial products such as Iganox can be used. However, it is not necessarily limited to these, and may be included in the range of 0.05 to 2 wt % in the entire dental 3D printing resin composition.

The photoinitiation aid is added to assist photoinitiation by a photoinitiator. For example, DIFP (diphenyliodonium hexafluorophosphate) may be used, but is not limited thereto, and may be included in the range of 0.01 to 1 wt % in the entire composition.

The coloring aid is added to assist in the fluorescence and color realization of the dental structure or structures printed with the resin composition according to the present invention, and may be included in the range of 0.1 to 5 wt % in the entire resin composition.

Food coloring may be used as the coloring aid, for example, among food colorings, azo pigments such as red No. 2, yellow No. 4, yellow No. 5, red No. 40, and red No. 102, xanthine pigments such as red No. 3, triphenylmethane pigments such as green No. 3 and blue No. 1, indigoid pigments such as blue No. 2, and the like may be used, but are not particularly limited thereto. Since these coloring aids are composed of edible colorings, they can enable more vivid color development and light emission by assisting the fluorescent light-emitting characteristics of the fluorescent coloring agent while ensuring human safety for use of the coloring agent.

The filler is added to improve the physical strength and wear resistance of the dental structure that is 3D-printed with the resin composition according to the present invention, and may be included in the weight range of 0.5 to 8 wt % in the entire composition. It is preferable that the filler is included within the above weight range in order to achieve the effect of improving strength and durability by the filler, while also preventing a problem such as filler detachment or deterioration of bonding strength due to an increase in the amount of the filler.

Such fillers include, for example, silica, strontium aluminum silicate, barium aluminum silicate, barium glass, kaolin, talc, radiopaque glass powder, zirconia compounds, and the like, but the types of fillers that can be applied in this embodiment are not limited to thereto.

Preferably, silica surface-treated with a silane coupling agent may be used to improve miscibility with hydrophobic polymerization monomers, and it is preferable to use a filler whose particle size is adjusted to 50 μm or less through a microsizing process.

When the particle size is within this range, filler aggregation is prevented and a space between filler particles is reduced, so that when a microcrack occurs in the fluorescent implant guide, an effective path length through which the crack can extend becomes longer.

Therefore, even if microcrack occurs, the filler is not easily destroyed, and the durability of the dental structure or structures printed with the resin composition according to the present invention can be effectively improved.

The viscosity modifier is added to control the viscosity of the resin composition according to the present invention, and TEGDMA (triethylene glycol dimethacrylate) may be used, but is not necessarily limited thereto.

The viscosity modifier may be included at 1 to 25 wt % in the entire composition, and when the viscosity modifier is included within the above weight range, the stirring characteristics and viscosity characteristics required for 3D printing are satisfied, so it is preferable that the viscosity modifier is included within the above weight range. In particular, when using TEGDMA as the viscosity modifier, defects due to excessive polymerization shrinkage may occur if the weight range is exceeded, so it is preferable that the viscosity modifier is not used in an amount exceeding the above weight range.

The fluorescent coloring agent is a substance that absorbs energy applied when irradiated with light and is converted to an excited state and then converted back to a ground state to emit fluorescence. The fluorescent coloring agent imparts fluorescent characteristics to the dental structure or structures printed with the resin composition according to the present invention, thereby improving visibility during the dental procedures. As a result, it is possible to more clearly and accurately recognize the location, angle, direction, depth, and the like during the perforation and implant placement processes during the dental procedures, and prevent side effects such as damage, bleeding, swelling, and infection due to incorrect positioning during the dental procedures in advance, and perform safe and efficient dental procedures that can satisfy both the patient and the operator.

As a biocompatible material of such a fluorescent coloring agent, DAPI (4′,6-Diamidino-2-phenylindole dihydrochloride) that is safe for the human body and has excellent fluorescence characteristics can be used. This material emits sufficient fluorescence even with a small amount of use, and has an advantage of being non-cytotoxic at low concentrations.

The fluorescent coloring agent may be used in an amount of 0.2 wt % or more to less than 1.6 wt %, 0.5 wt % or more to less than 1.6 wt %, or 0.8 wt % or more to less than 1.6 wt % in the entire composition. If the content of the fluorescent coloring agent is less than the above range, the illuminance of the lighting installed in a general dental unit chair does not emit sufficient fluorescence, so there is little effect in improving visibility, and if the content of the fluorescent coloring agent is 1.6 wt % or more, it is difficult to use the fluorescent coloring agent as the dental material due to cytotoxicity, so it is preferable that the fluorescent coloring agent is included in the dental 3D printing resin composition in an amount that satisfies the above weight range. In addition, considering both fluorescent coloring property and cytotoxicity, it is more preferable that the fluorescent coloring agent is included at 0.5 to 1.2 wt %.

Meanwhile, another embodiment of the present invention includes a manufacturing method of a 3D printing resin composition.

The manufacturing method of a 3D printing resin composition according to a specific embodiment includes steps of mixing BIS-GMA, BIS-EMA, UDMA, photoinitiator, additive, coloring aid, filler, viscosity modifier, and fluorescent coloring agent to manufacture the 3D printing resin composition. Contents that overlap or are identical to the contents of the 3D printing resin composition described above will be omitted and the explanation will focus on the manufacturing process.

Specifically, the manufacturing method of a 3D printing resin composition according to the present invention includes a first mixing step of mixing BIS-GMA, BIS-EMA, and UDMA and stirring to manufacture a first mixture; a second mixing step of adding a photoinitiator and an additive to the first mixture and stirring to manufacture a second mixture; a third mixing step of adding a coloring agent mixture to the second mixture and stirring to manufacture a third mixture; a fourth mixing step of adding a filler to the third mixture and stirring to manufacture a fourth mixture; and a fifth mixing step of adding a viscosity modifier to the fourth mixture and stirring to manufacture a 3D printing resin composition. At this time, the coloring agent mixture mixed in the third mixing step may be a mixture of UDMA, a fluorescent coloring agent, and a coloring aid.

Each mixing step can be performed at a room temperature of 10 to 25° C., the stirring speed can be 5 to 12 RPM, and can be performed under reduced pressure conditions with a vacuum gauge pressure of 0.05 to 0.15 MPa to prevent bubble generation during stirring.

The first mixing step is a step of mixing BIS-GMA, BIS-EMA, and UDMA and stirring to manufacture the first mixture. At this step, 30 to 60 wt % of BIS-GMA, 10 to 30 wt % of BIS-EMA, and 3 to 18 wt % of UDMA can be mixed based on the final composition, and the ratios of the raw material ingredients mentioned in the following steps are all based on the final composition, and means the weight range included in the final composition.

Here, UDMA is additionally mixed in the third mixing step which will be described later, so only a portion of the total weight can be mixed in this step. In this step, stirring may be performed for 150 to 300 minutes, preferably for 180 to 240 minutes, and the stirring time may vary depending on the season, and the stirring may be performed for a short time in the summer and for a long time in the winter within the above stirring time range.

The second mixing step is a step of adding the photoinitiator and the additive to the first mixture and stirring to manufacture the second mixture. Here, 1 to 10 wt % of the photoinitiator and 0.01 to 5 wt % of the additive may be added. In this step, stirring may be performed for 150 to 300 minutes, preferably for 180 to 240 minutes, and the stirring time may vary depending on the season, and the stirring may be performed for a short time in the summer and for a long time in the winter within the above stirring time range.

The third mixing step is a step of adding the coloring agent mixture to the second mixture and stirring to manufacture the third mixture. The coloring agent mixture is a mixture of UDMA, the fluorescent coloring agent, and the coloring aid. Coloring substances can be more uniformly dispersed and stably mixed when UDMA, fluorescent coloring agent, and coloring aid are premixed and added in the form of a manufactured coloring agent mixture rather than adding each raw material individually in the third mixing step. At this stage, UDMA may be added in the weight range of 2 to 12 wt, coloring aid may be added in the weight range of 0.1 to 5 wt %, and fluorescent coloring agent may be added in the weight range of 0.2 wt % or more to less than 1.6 wt %.

The fourth mixing step is a step of adding the filler to the third mixture and stirring to manufacture the fourth mixture. The filler may be added at 0.5 to 8 wt % and stirred.

In the third mixing step and the fourth mixing step, stirring may be performed for 300 minutes or more, preferably for more than 360 minutes, and is preferably performed for 480 minutes or more in case of low temperatures such as the winter.

The fifth mixing step is a step of adding the viscosity modifier to the fourth mixture and stirring to manufacture a composition for an implant guide, and the viscosity modifier may be included at 1 to 25 wt %. Stirring may be performed for 150 to 300 minutes, preferably for 180 to 240 minutes, and within this stirring time range, and the stirring may be performed for a short time in the summer and for a long time in the winter within the above stirring time range.

After the fifth mixing step, an additional bubble removal step may be performed to remove air bubbles in the composition for the implant guide. In this bubble removal step, for example, a bubble removal process of vacuum defoaming or low-temperature aging (0 to 15° C.) may be performed.

A step of manufacturing a dental structure used in dental implant procedures, such as the implant guide, can be performed through the 3D printing process using the 3D printing resin composition manufactured in this way.

The fluorescent dental structure manufactured through 3D printing can be cured through additional light irradiation, and the fluorescent dental structure manufactured through this step can be customized for the patient to increase the accuracy of dental procedures, and fluorescence is emitted through light irradiation of the lighting installed in a dental unit chair, and thereby more accurate and safer procedures can be performed. Next, a fluorescent implant guide and a manufacturing method thereof will be described according to another embodiment of the present invention. Since the fluorescent implant guide according to the present invention emits fluorescence when irradiated with light, it can accurately guide the position, angle, direction, and depth of perforation, drilling, and implant placement during implant procedure, thereby preventing side effects such as perforation or placement location errors, abnormal bleeding, swelling, infection, and nerve damage in advance, and enabling safe and more accurate implant procedure.

A fluorescent implant guide according to an embodiment of the present invention includes a guide body in which at least one or more holes is formed. Among these, the guide body is supported on the teeth or gums to fix the position of the fluorescent implant guide, and the hole is provided to guide the entry position, angle, direction, depth, and the like of the drill or implant during perforation and placement. Since the fluorescent implant guide is custom-made for the patient, the shape thereof is not particularly limited as long as the guide body or the hole is formed in a shape that can achieve the above-mentioned purpose.

The guide body may be formed by curing a composition for the implant guide including BIS-GMA, BIS-EMA, UDMA, photoinitiator, additive, coloring aid, filler, viscosity modifier, and fluorescent coloring agent.

As the composition for the implant guide, the 3D printing resin composition according to the previously described embodiment may be used, and overlapping content will be omitted to avoid repetition of the same description.

The fluorescent implant guide formed by curing the composition for the implant guide has a bending strength of 65 MPa or more required by the Ministry of Food and Drug Safety Notification of Korea, and can provide stable support against pressure and distortion applied during drilling operation for perforation. In addition, fluorescence is emitted from a light source of 8,000 lux or more, which is slightly lower than the average illuminance of lighting (approximately 9,500 lux) of the general dental unit chair. Therefore, it has the advantage of allowing the operator to more easily and accurately check the location of the perforation or placement, and being made of biocompatible materials and being safe without any toxicity to the human body.

More specifically, the dental 3D printing resin composition, which is the composition of the implant guide used in the manufacturing of the fluorescent implant guide, may include 30 to 60 wt % of BIS-GMA, 10 to 30 wt % of BIS-EMA, 5 to 30 wt % of UDMA, 1 to 10 wt % of photoinitiator, 0.01 to 5 wt % of additive, 0.1 to 5 wt % of coloring aid, 0.5 to 8 wt % of filler, 1 to 25 wt % of viscosity modifier, and 0.2 wt % or more to less than 1.6 wt % of fluorescent coloring agent.

The filler is added to improve the physical strength and wear resistance of the fluorescent implant guide and may be included in the weight range of 0.5 to 8 wt % in the entire composition. It is preferable that the filler is included within the above weight range in order to achieve the effect of improving strength and durability by the filler, while also preventing a problem such as filler detachment or deterioration of bonding strength due to an increase in the amount of the filler.

Preferably, silica surface-treated with a silane coupling agent may be used to improve miscibility with hydrophobic polymerization monomers, and it is preferable to use a filler whose particle size is adjusted to 50 μm or less through a microsizing process.

When the particle size is within this range, filler aggregation is prevented and a space between filler particles is reduced, so that when a microcrack occurs in the fluorescent implant guide, an effective path length through which the crack can extend becomes longer. Therefore, even if microcrack occurs, the filler is not easily destroyed, and the durability of the fluorescent implant guide can be improved.

The viscosity modifier is added to control the viscosity of the composition for the implant guide, and TEGDMA (triethylene glycol dimethacrylate) may be used. The viscosity modifier may be included at 1 to 25 wt % in the 3D printing resin composition which is the composition for the implant guide, and when the viscosity modifier is included within the above weight range, the stirring characteristics and viscosity characteristics required for 3D printing are satisfied, so it is preferable that the viscosity modifier is included within the above weight range. In particular, when using TEGDMA as the viscosity modifier, defects due to excessive polymerization shrinkage may occur if the weight range is exceeded, so it is preferable that the viscosity modifier is not used in an amount exceeding the above weight range.

The fluorescent coloring agent is a substance that absorbs energy applied when irradiated with light and is converted to an excited state and then converted back to the ground state to emit fluorescence. The fluorescent coloring agent imparts fluorescent characteristics to the fluorescent implant guide, thereby improving visibility of the implant guide during the implant procedure. As a result, t is possible to more clearly and accurately guide the location, angle, direction, depth, and the like during the perforation and implant placement processes during the implant procedure, and prevent side effects such as damage, bleeding, swelling, and infection due to incorrect positioning during the implant procedure in advance, and perform safe and efficient implant procedure that can satisfy both the patient and the operator.

As a biocompatible material of such a fluorescent coloring agent, DAPI (4′,6-Diamidino-2-phenylindole dihydrochloride) that is safe for the human body and has excellent fluorescence characteristics can be used. This material emits sufficient fluorescence even with a small amount of use, and has an advantage of being non-cytotoxic at low concentrations.

The fluorescent coloring agent may be used in an amount of 0.2 wt % or more to less than 1.6 wt %, 0.5 wt % or more to less than 1.6 wt %, or 0.8 wt % or more to less than 1.6 wt % in the dental 3D printing resin composition which is the composition for the implant guide. If the content of the fluorescent coloring agent is less than the above range, the illuminance of the lighting installed in a general dental unit chair does not emit sufficient fluorescence, so there is little effect in improving visibility.

Conversely, if the content of the fluorescent coloring agent is 1.6 wt % or more, it is difficult to use the fluorescent coloring agent as the dental material due to cytotoxicity, so it is preferable that the fluorescent coloring agent is included in the composition for the implant guide in an amount that satisfies the above weight range. In addition, considering both fluorescent coloring property and cytotoxicity, it is more preferable that the fluorescent coloring agent is included at 0.5 to 1.2 wt %.

Meanwhile, another embodiment of the present invention is a manufacturing method of a fluorescent implant guide. Specifically, the manufacturing method of a fluorescent implant guide includes a guide design step of designing the shape of the implant guide based on the patient's oral cavity information; an implant guide composition manufacturing step of mixing BIS-GMA, BIS-EMA, UDMA, photoinitiator, additive, coloring aid, filler, viscosity modifier, and fluorescent coloring agent to manufacture the composition for implant guide; and an implant guide manufacturing step of manufacturing a patient-customized fluorescent implant guide by 3D printing the composition for the implant guide in the form of the implant guide designed in the guide design step.

The guide design step is a step of designing the shape of the implant guide based on the patient's oral cavity information. The patient's oral cavity information may include any one or more of oral internal information of the patient obtained by scanning the oral cavity using a 3D scanner, oral cavity information obtained by scanning a plaster modeled after the patient's oral cavity with a 3D scanner, and oral cavity information obtained by CT scanning. The shape of the implant guide can be designed by inputting the patient's oral cavity information into an implant guide design program. Through these steps, the location, direction, angle, depth, and the like of perforation and implant placement during the implant procedure can be set.

The implant guide composition manufacturing step is a step of mixing BIS-GMA, BIS-EMA, UDMA, photoinitiator, additive, coloring aid, filler, viscosity modifier, and fluorescent coloring agent to manufacture the composition for implant guide. Since the composition for the implant guide manufactured through this step may be the same as the dental 3D printing resin composition described in an embodiment of the present invention, some overlapping descriptions will be omitted.

Specifically, the manufacturing step of the 3D printing resin composition that is the composition for the implant guide includes a first mixing step of mixing BIS-GMA, BIS-EMA, and UDMA and stirring to manufacture a first mixture; a second mixing step of adding a photoinitiator and an additive to the first mixture and stirring to manufacture a second mixture; a third mixing step of adding a coloring agent mixture to the second mixture and stirring to manufacture a third mixture; a fourth mixing step of adding a filler to the third mixture and stirring to manufacture a fourth mixture; and a fifth mixing step of adding a viscosity modifier to the fourth mixture and stirring to manufacture the composition for the implant guide. At this time, the coloring agent mixture mixed in the third mixing step may be a mixture of UDMA, a fluorescent coloring agent, and a coloring aid.

Next, a step of manufacturing the fluorescent implant guide using a 3D printing process is performed. During 3D printing, 3D printing can be performed by using the composition for the implant guide as ink, and using the composition for the implant guide as a design drawing of the shape of the implant guide designed in the guide design stage.

The fluorescent implant guide manufactured through 3D printing can be additionally cured through light irradiation, and the fluorescent implant guide manufactured through this step can be customized for the patient to increase the accuracy of the implant procedure, and fluorescence is emitted through light irradiation of the lighting installed in a dental unit chair, and thereby more accurate and safer procedures can be performed.

Below, the specific operations and effects of the present invention will be explained through specific examples of the present invention. However, those are presented as preferred examples of the present invention, and the scope of the present invention is not limited by the examples.

### Manufacturing Example 1

40 g of DMBIS-GMA, 27 g of BIS-EMA, and 7 g of UDMA were mixed and stirred for 200 minutes to manufacture the first mixture, in which 0.8 g of camphorquinone and 2.7 g of TPO as the photoinitiator, 0.3 g of an accelerator (EDMAB) as the additive, 0.6 g of antioxidant (BHT), and 0.1 g of photoinitiation aid (DIFP) were added and stirred for 200 minutes to manufacture the second mixture. 4.6 g of UDMA, 0.8 g of DAPI that is the fluorescent coloring agent, and 0.2 g of food coloring blue No. 1 and 0.2 g of food coloring red No. 40, which are coloring aids were mixed to manufacture the coloring agent mixture, then add the entire amount thereof to the second mixture and stirred for 320 minutes to manufacture the third mixture. Here, 5 g of silane-modified silica (particle size 50 μm or less) as the filler was added thereto and stirred for 300 minutes to manufacture the fourth mixture.

Next, 10.8 g of TEGDMA that is the viscosity modifier was added to the fourth mixture, stirred for 200 minutes, and aged at 5° C. for 24 hours to remove air bubbles to manufacture the dental 3D printing resin composition of Example 1.

### Experimental Example 1

The same method as Manufacturing Example 1, which is a method of manufacturing the dental 3D printing resin composition of Example 1 was used, and pure BIS-GMA instead of DMBIS-GMA, which is a modified BIS-GMA was used to manufacture the composition for the implant guide of Comparative Example 1. The compositions of Example 1 and Comparative Example 1 were manufactured using a 3D printer and printed in a size of 64 mm×10 mm×33 mm and cured to manufacture five specimens respectively.

Next, the specimen was mounted on the universal testing machine and bent at a speed of 5 mm/min until fracture, the load F at fracture was recorded, and the thickness h and width b of the specimen were measured to calculate a bending strength OB using the equation below. In Equation 1, “I” refers to the distance between the supports of the universal testing machine. Five specimens were manufactured for Example 1 and Comparative Example 1, respectively, and an experiment was performed on each specimen, and the bending strength was calculated. Then, the results and average values were listed in Table 1.

$${σ}_{B} = \frac{3 FI}{2 {bh}^{2}} \qquad ( Equation 1 )$$

TABLE 1

| | | | Comparative |
|---|---|---|---|
| | | Example 1 | Example 1 |
| Bending strength | First time | 95.3 | 75.3 |
| (MPa) | Second time | 101.8 | 70.0 |
| | Third time | 106.2 | 73.1 |
| | Fourth time | 101.4 | 76.2 |
| | Fifth time | 98.5 | 72.5 |
| | Average | 100.6 | 73.4 |

Referring to the experimental results in Table 1, it was found that the bending strength of the specimen of Example 1 to which modified BIS-GMA was applied was significantly higher than that of Comparative Example 1 to which non-modified BIS-GMA was applied. Both Example 1 and Comparative Example 1 were confirmed to have the bending strength of 65 MPa or more, which is the bending strength required for the implant perforation procedure. However, considering the dental structure, or the pressure or distortion applied to the dental structure, because the higher the bending strength, the more the specimen is, it is more preferable to use the dental 3D printing resin composition of Example 1.

### Experimental Example 2

The same method as Manufacturing Example 1, which is the manufacturing method of the composition for the implant guide of Example 1 was used, the content of the fluorescent coloring agent was increased to 1.6 g, and the content of DMBIS-GMA was lowered by the increased amount to manufacture the composition for the implant guide of Comparative Example 2.

Example 1 and Comparative Example 2 were manufactured as film specimens of 20×20×2 mm, a cytotoxicity test was performed on mouse fibroblasts (L-929) using three specimens, respectively from the Korea Construction and Living Testing Institute, and the results were listed in Table 2. The test results were evaluated using a 5-point scale depending on the degree of reactivity, with 0 in the case of no reaction and 4 in the case where the reaction occurred to the extent that the cell layer was almost destroyed.

TABLE 2

| Specimen number | Example 1 | Comparative Example 2 |
|---|---|---|
| #1 | 0 | 4 |
| #2 | 0 | 4 |
| #3 | 0 | 4 |

Referring to the experimental results in Table 2 above, in the case of Example 1, no cytotoxicity was confirmed, but in the case of Comparative Example 2, the cytotoxic reaction was confirmed. Therefore, as a result of this experiment, it was confirmed that it is preferable that the fluorescent coloring agent is included at 0.8 wt % and not included at 1.6 wt %.

In particular, considering cytotoxicity, it is preferable to include less than 1.6 wt %, and considering that toxicity increases as the content of the fluorescent coloring agent increases, it can be predicted that it is preferable to include in an amount of 1.2 wt % or less to satisfy cytotoxicity level 2 which is equivalent to class 2 medical device.

In addition, in the case of the fluorescent coloring agent, when it is included in an amount of 0.5 wt % or more, color is developed to a level that can be easily observed with the naked eye. Therefore, considering these factors, it can be seen that the preferable content of the fluorescent coloring agent is 0.5 to 1.2 wt %.

### Experimental Example 3

The composition for the implant guide was manufactured in the same method as Manufacturing Example 1, and the contents of fluorescent coloring agent (DAPI), food coloring (blue No. 1 and red No. 40), and UDMA included in the coloring agent mixture were changed as shown in Table 3 to manufacture the dental 3D printing resin compositions of Example 2, Example 3, and Comparative Example 3.

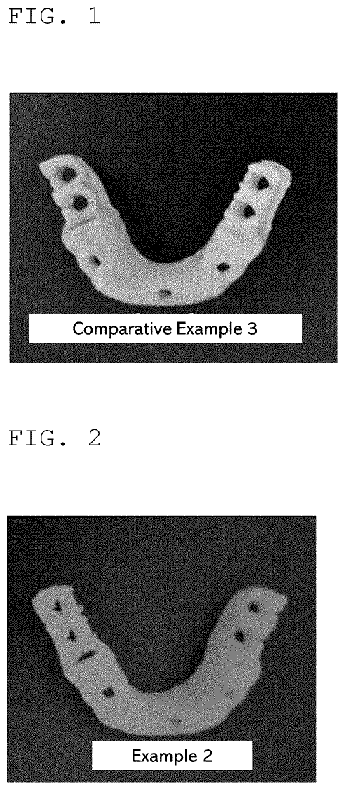

Next, using Examples 2 and 3, and Comparative Example 3, implant guide models, which are dental structures, were manufactured through 3D printing, then irradiated with light, and photographed, and the results thereof were presented in FIGS. 1-4. The content of each raw material in Table 3 refers to the content in the entire dental 3D printing resin composition.

TABLE 3

| | | | Comparative |
|---|---|---|---|
| (Unit: wt %) | Example 2 | Example 3 | Example 3 |
| UDMA | 6.3 | 6.3 | 7.1 |
| Fluorescent | 0.8 | 0.8 | — |
| coloring agent | | | |
| Blue No. 1 | — | 0.2 | — |
| Red No. 40 | 0.2 | — | 0.2 |

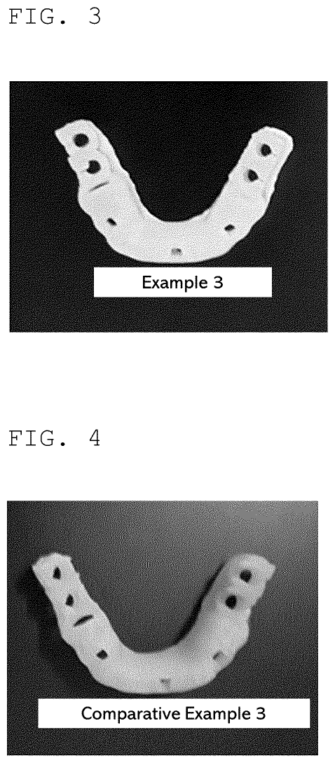

Referring to the results in FIGS. 1-4, Comparative Example 3, shown in FIGS. 1 and 4, which did not include the fluorescent coloring agent, simply expressed color due to the pigment, but Examples 2 and 3, shown in FIGS. 2 and 3, which included 0.8 wt % of the fluorescent coloring agent, appeared to emit fluorescence. Although fluorescence does not appear clearly in the photograph, strong fluorescence was confirmed to be emitted when observed with the naked eye.

Therefore, from the results of this experiment, it was confirmed that when the fluorescent coloring agent was included at 0.8 wt %, sufficiently strong fluorescence was emitted to improve visibility during implant procedure. In addition, since the fluorescence intensity is directly proportional to the content of the fluorescent coloring agent, it can be predicted that sufficient fluorescence to improve visibility will be emitted even at a content slightly lower than 0.8 wt %, for example, 0.5 wt %.

### INDUSTRIAL APPLICABILITY

The dental 3D printing resin composition according to the present invention includes BIS-GMA (bisphenol A-glycidyl methacrylate), BIS-EMA (ethoxylated bisphenol A dimethacrylate), UDMA (urethane dimethacrylate), photoinitiator, additive, coloring aid, filler, viscosity regulator, and fluorescent coloring agent, fluorescent characteristics are imparted to the dental structure such as the implant guide or tooth restoration resin manufactured using the same, and thereby the operator can more effectively recognize the placement location, direction, depth, and the like of the dental structure, while at the same time securing sufficient physical and mechanical strength, so that industrial applicability exists.

1. A 3D printing resin composition including:
bisphenol A-glycidyl methacrylate (BIS-GMA), ethoxylated bisphenol A dimethacrylate (BIS-EMA), urethane dimethacrylate (UDMA), a photoinitiator, an additive, a coloring aid, a filler, a viscosity modifier, and a fluorescent coloring agent.

2. The 3D printing resin composition according to claim 1,
wherein the fluorescent coloring agent is 4′,6-Diamidino-2-phenylindole dihydrochloride (DAPI).

3. The 3D printing resin composition according to claim 1,
wherein the fluorescent coloring agent is included in a range of 0.2 wt % or more to less than 1.6 wt %.

4. The 3D printing resin composition according to claim 1,
wherein the additive is at least one or more of an accelerator, an antioxidant, and a photoinitiation aid.

5. A manufacturing method of a 3D printing resin composition, the manufacturing method comprising:
a first mixing step of mixing BIS-GMA, BIS-EMA, and UDMA and stirring to manufacture a first mixture;
a second mixing step of adding a photoinitiator and an additive to the first mixture and stirring to manufacture a second mixture;
a third mixing step of adding a coloring agent mixture to the second mixture and stirring to manufacture a third mixture;
a fourth mixing step of adding a filler to the third mixture and stirring to manufacture a fourth mixture; and
a fifth mixing step of adding a viscosity modifier to the fourth mixture and stirring to manufacture a composition for an implant guide,
wherein the coloring agent mixture is a mixture of UDMA, a fluorescent coloring agent, and a coloring aid.

6. The manufacturing method of a 3D printing resin composition according to claim 5,
wherein the fluorescent coloring agent is 4′,6-Diamidino-2-phenylindole dihydrochloride (DAPI).

7. The manufacturing method of a 3D printing resin composition according to claim 5,
wherein the fluorescent coloring agent is included in a range of 0.2 wt % or more to less than 1.6 wt %.

8. A fluorescent implant guide including a guide body in which at least one or more holes are formed,
wherein the guide body is formed by curing a composition for an implant guide including bisphenol A-glycidyl methacrylate (BIS-GMA), ethoxylated bisphenol A dimethacrylate (BIS-EMA), urethane dimethacrylate (UDMA), a photoinitiator, an additive, a coloring aid, a filler, a viscosity modifier, and a fluorescent coloring agent.

9. The fluorescent implant guide according to claim 8,
wherein the fluorescent coloring agent is 4′,6-Diamidino-2-phenylindole dihydrochloride (DAPI).

10. The fluorescent implant guide according to claim 8, the content of the fluorescent coloring agent included in the composition for the implant guide is 0.2 wt % or more to less than 1.6 wt %.

11. The fluorescent implant guide according to claim 8,
wherein the composition for the implant guide includes 30 to 60 wt % of bisphenol A-glycidyl methacrylate (BIS-GMA), 10 to 30 wt % of ethoxylated bisphenol A dimethacrylate (BIS-EMA), 5 to 30 wt % of urethane dimethacrylate (UDMA), 1 to 10 wt % of the photoinitiator, 0.01 to 5 wt % of the additive, 0.1 to 5 wt % of the coloring aid, 0.5 to 8 wt % of the filler, 1 to 25 wt % of the viscosity modifier, and 0.2 wt % or more to less than 1.6 wt % of the fluorescent coloring agent.
